(19) United States
(12) Patent Application Publication
(10) Pub. No.: US 2018/0107655 A1
(43) Pub. Date: Apr. 19, 2018

(54) SYSTEMS AND METHODS FOR HANDLING FORMALITY IN TRANSLATIONS OF TEXT

(71) Applicant: Google Inc., Mountain View, CA (US)

(72) Inventors: Melvin Jose Johnson Premkumar, Mountain View, CA (US); Sarah Nguyen, Mountain View, CA (US); Klaus Macherey, Sunnyvale, CA (US)

(73) Assignee: Google Inc., Mountain View, CA (US)

(21) Appl. No.: 15/295,582

(22) Filed: Oct. 17, 2016

(51) Int. Cl. G06F 17/28

(52) U.S. Cl. CPC G06F 17/289; G06F 17/2872

(57) ABSTRACT

A computer-implemented method can include obtaining, by a server computing device, a machine translation model relating sets of source words in a source language to sets of target words in a different target language, each of the sets of source words and target words being labeled with a level of formality with respect to its corresponding language. The method can include receiving, by the server computing device, a request to obtain a translated text representing a translation of a text from the source language to the target language, the request further specifying a desired level of formality for the translated text. The method can include in response to receiving the request, obtaining, by the server computing device, the translated text by translating the text using the machine translation model and the desired level of formality. The method can further include outputting, by the server computing device, the translated text.

### FIELD

The present disclosure generally relates to machine language translation and, more particularly, to systems and methods for handling formality in translations of text.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Machine language translation involves a computing system (e.g., a server computing device) obtaining a translated text representing a translation of a text from a source language to a different target language. Many languages, such as Romance and Germanic languages, distinguish between formal and informal speech. In French, for example, the pronouns “tu” and “vous” both mean “you,” but the former is informal whereas the latter is formal. More particularly, when speaking to a friend or family member, a French speaker may use the pronoun “tu,” but in a more formal setting, such as a business meeting with colleagues that the speaker does not know very well, she/he may use the pronoun “vous.” In addition, the selected pronoun can further affect how corresponding verbs are conjugated.

### SUMMARY

According to one aspect of the present disclosure, a computer-implemented method is presented. In one implementation, the method can include obtaining, by a server computing device, a machine translation model relating sets of source words in a source language to sets of target words in a different target language, each of the sets of source words and target words being labeled with a level of formality with respect to its corresponding language; receiving, by the server computing device, a request to obtain a translated text representing a translation of a text from the source language to the target language, the request further specifying a desired level of formality for the translated text; in response to receiving the request, obtaining, by the server computing device, the translated text by translating the text using the machine translation model and the desired level of formality; and outputting, by the server computing device, the translated text.

In some implementations, the translated text comprises a first set of target words that is labeled with a level of formality that corresponds to the desired level of formality. In some implementations, translating the text comprises obtaining a probability score for the first set of target words and a second set of target words, each probability score being indicative of a likelihood that its respective set of target words is an appropriate translation of a set of source words corresponding to the text, and the probability score for the second set of target words is greater than the probability score for the first set of target words. In some implementations, each of the labeled and desired levels of formality is either formal or informal. In some implementations, each of the labeled and desired levels of formality is one of three or more levels of formality ranging from informal to formal.

In some implementations, the machine translation model is a phrase-based machine translation model that comprises a labeled phrase table comprising a plurality of pairs of parallel phrases, and each pair of parallel phrases comprises a source phrase in the source language and a target phrase in the target language, and each source phrase and each target phrase is labeled with the level of formality. In some implementations, the machine translation model is a neural network-based machine translation model.

According to another aspect of the present disclosure, a server computing device is presented. In one implementation, the server computing device can comprise a non-transitory computer-readable medium having a set of instructions stored thereon; and one or more processors configured to execute the set of instructions, which causes the server computing device to perform operations. The operations can comprise obtaining, by a server computing device, a machine translation model relating sets of source words in a source language to sets of target words in a different target language, each of the sets of source words and target words being labeled with a level of formality with respect to its corresponding language; receiving, by the server computing device, a request to obtain a translated text representing a translation of a text from the source language to the target language, the request further specifying a desired level of formality for the translated text; in response to receiving the request, obtaining, by the server computing device, the translated text by translating the text using the machine translation model and the desired level of formality; and outputting, by the server computing device, the translated text.

In some implementations, the translated text comprises a first set of target words that is labeled with a level of formality that corresponds to the desired level of formality. In some implementations, translating the text comprises obtaining a probability score for the first set of target words and a second set of target words, each probability score being indicative of a likelihood that its respective set of target words is an appropriate translation of a set of source words corresponding to the text, and the probability score for the second set of target words is greater than the probability score for the first set of target words. In some implementations, each of the labeled and desired levels of formality is either formal or informal. In some implementations, each of the labeled and desired levels of formality is one of three or more levels of formality ranging from informal to formal.

In some implementations, the machine translation model is a phrase-based machine translation model that comprises a labeled phrase table comprising a plurality of pairs of parallel phrases, and each pair of parallel phrases comprises a source phrase in the source language and a target phrase in the target language, and each source phrase and each target phrase is labeled with the level of formality. In some implementations, the machine translation model is a neural network-based machine translation model.

According to another aspect of the present disclosure, a computer-implemented method is presented. In one implementation, the method can include obtaining, by a client computing device, a text in a source language; determining, by the client computing device, a desired level of formality for a translated text representing a translation of the text from the source language to a different target language; transmitting, by the client computing device and to a server computing device, a request to translate the text to the target language, the request further specifying the desired level of formality, and receipt of the request causes the server computing device to: obtain the translated text by translating the text from the source language to the target language using a machine translation model and the desired level of formality, and the machine translation model relates sets of source words in the source language to sets of target words in the target language, each of the sets of source words and target words being labeled with a level of formality with respect to its corresponding language; receiving, by the client computing device and from the server computing device, the translated text; and outputting, by the client computing device, the translated text.

In some implementations, each of the desired and labeled levels of formality is either formal or informal. In some implementations, the method can further comprise receiving, by the client computing device and from a user, an input specifying the desired level of formality as either formal or informal. In some implementations, the method can further comprise displaying, by the client computing device, a toggle button configured to switch between the desired level of formality being formal and informal, and the input received from the user is received with respect to the toggle button.

In some implementations, determining the desired level of formality is performed by the client computing device without any specific input from the user. In some implementations, the method can further comprise initiating, by the client computing device, composition of an electronic message from the user to a recipient, and determining the desired level of formality is performed by the client computing device based on a history of communications between the user and the recipient.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example computing system for handling formality in translations of text according to some implementations of the present disclosure;

FIG. 2 is a functional block diagram of an example computing device for handling formality in translations of text according to some implementations of the present disclosure;

FIG. 3A is a flow diagram of an example first method for handling formality in translations of text according to some implementations of the present disclosure;

FIG. 3B is a flow diagram of an example second method for handling formality in translations of text according to some implementations of the present disclosure; and

FIGS. 4A-4C illustrate example user interfaces according to some implementations of the present disclosure.

### DETAILED DESCRIPTION

As mentioned above, the level of formality can affect text translations for particular languages, such as Romance and Germanic languages. Conventional machine translation systems, however, do not take into account a desired level of formality when providing translated text. The translated text, therefore, can have a different level of formality than is desired (e.g., informal when formal was intended), which could be offensive to another user, such as a recipient of an electronic message comprising the translated text or the text from which the translated text is then obtained. Accordingly, improved systems and methods are presented for handling formality in translations of text.

The systems and methods discussed herein utilize a desired level of formality as a factor in obtaining a translated text. In some implementations, the desired level of formality is either formal or informal (colloquial). For example, the desired level of formality could be either user-specified (e.g., via a manual input to a toggle button). It will be appreciated that the desired level of formality could also be one of three or more desired levels of formality (e.g., formal, semi-formal, and informal). Alternatively, there could be three levels of formality including formal, informal, and non-applicable or “does not apply” (e.g., for the phrase “the car is blue,” there is no associated formality. The desired level of formality could also be automatically determined, based on past user activity, by a client computing device and/or a server computing device. For example, when the text to be translated is part of an electronic message, a history of communications between the sender and recipient could be analyzed to determine the desired level of formality. This desired level of formality is obtained by the server computing device along with a request to translate the text.

The server computing device can utilize a machine translation model and the desired level of formality to obtain the translated text. This machine translation model can differ from conventional machine translation models in that its sets of source/target words are labeled with a level of formality. More particularly, the machine translation model can relate sets of source words in the source language to sets of target words in the target language, and each of the sets of source words and target words can be labeled with a level of formality. This labeling could be performed, for example, by native speakers of the associated language and/or via machine learning/training. Examples of the machine translation model include a phrase-based machine translation model and a neural network-based machine translation model, but it will be appreciated that any suitable machine translation model could be used (e.g., a statistical machine translation model).

In some implementations, the server computing device utilizes the machine translation model to obtain a probability score for first and second target sets of words in the target language. Each probability score can be indicative of a likelihood that its associated set of target words is an appropriate translation of a corresponding set of source words that represent the text. The probability scores for the first and second sets of target words can be, for example, the two highest relative probability scores. Even though the second probability score is greater than the first probability score (indicative of a more likely appropriate translation), however, the first set of target words may be labeled with a level of formality that more closely matches the desired level of formality compared to the label for the second set of target words. For example, the first set of target words may be labeled as “formal” and the desired level of formality may be “formal,” but the second set of target words may be labeled as “informal.”

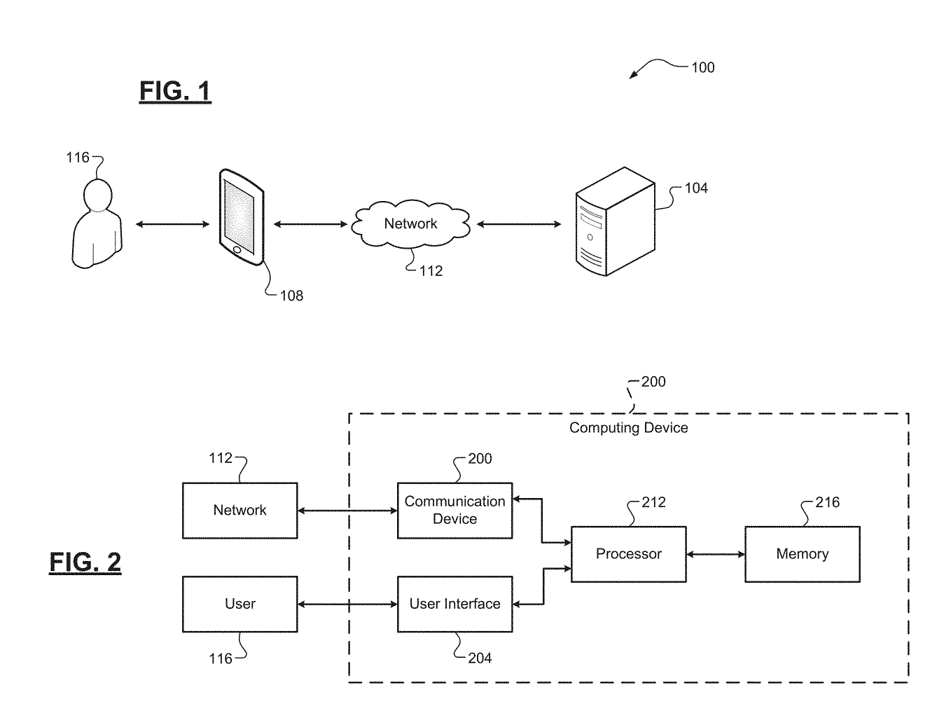

Referring now to FIG. 1, an example computing system 100 is illustrated. The computing system 100 can include a server computing device 104 that is in communication with a client computing device 108 via a network 112. The network 112 can be a local area network (LAN), a wide area network (WAN), e.g., the Internet, or a combination thereof. The term “server computing device” as used herein can refer to a single hardware server device or a plurality of hardware server devices operating in a parallel or distributed architecture. The client computing device 108 can be any suitable personal computing device (a desktop computer, a laptop computer, a tablet computer, a mobile phone, a wearable computer, etc.). The client computing device 108 can transmit a request to translate a text from a source language to a different target language. This request can be transmitted, for example, in response to an input from a user 116. A desired level of formality can also be determined by the client computing device and transmitted to the server computing device 104, determined by the server computing device 104, or some combination thereof.

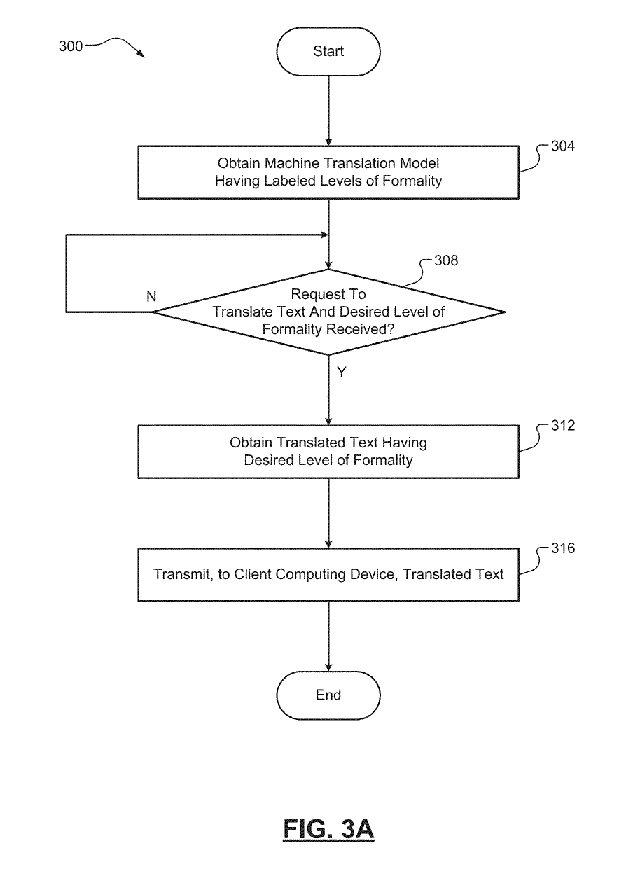

Referring now to FIG. 2, a functional block diagram of an example computing device 200 is illustrated. The computing device 200 can represent a configuration for the server computing device 104, the client computing device 108, or both. It will be appreciated that the server and client computing devices 104, 108 could also include different components. For example, the client computing device 108 may include certain components (a display, a camera, a microphone, etc.) that the server computing device 104 does not. The computing device 200 can include a user interface 204 (e.g., a touch display and/or a microphone), a communication device 208 (e.g., a transceiver), a processor 212, and a memory 216. The user interface 204 can The communication device 208 can be configured for communication by the computing device 200 via the network 112. The user interface 204 is configured to receive physical input (e.g., via a virtual keyboard displayed by a touch display or physical buttons) and/or voice input (e.g., via a microphone).

The term “processor” as used herein can refer to both a single processor and two or more processors operating in a parallel or distributed architecture. The processor 212 can control operation of the computing device 200. Example functions performed by the processor 212 include, but are not limited to, loading/executing an operating system, controlling the communication device 208, and controlling read/write operations at the memory 216. The memory 216 can be any suitable non-transitory computer-readable medium (flash, hard disk, etc.) that is configured to store information at the computing device 200. The memory 216, for example, can store a set of instructions that, when executed by the processor 212, cause the computing device 200 to perform at least a portion of the operations of the present disclosure, which are now discussed in greater detail.

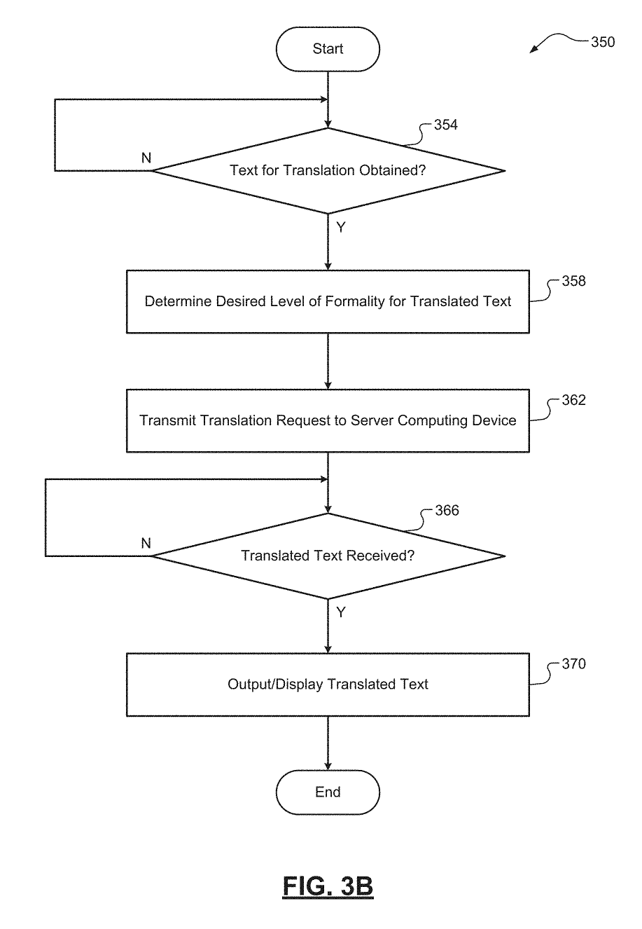

Referring now to FIG. 3A, a flow diagram of an example method 300 for handling formality in translations of text is illustrated. At 304, the server computing device 104 can obtain a machine translation model relating sets of source words in a source language to sets of target words in a different target language. Obtaining the machine translation model can include retrieving it from or accessing it via a memory (e.g., memory 216) or generating the machine translation model. Examples of the sets of words include phrases and sentences. Each of the sets of source words and target words can be labeled with a level of formality with respect to its corresponding language. As previously mentioned, this labeling can be manual annotations by fluent or native speakers of the respective languages and/or machine learned labels.

Non-limiting examples of the machine translation model include a phrase-based machine translation model and a neural network-based machine translation model. Other machine translation models (e.g., a statistical machine translation model) could also be utilized. A phrase-based machine translation model, for example, may include a labeled phrase table comprising a plurality of pairs of parallel or aligned phrases, where each pair of parallel phrases comprises a source phrase in the source language and a target phrase in the target language, and where each of the source phrase and the target phrase is labeled with the level of formality.

In some implementations, the labeling will be a binary labeling (e.g., formal or informal). In other implementations, however, the labeling will be one of three or more levels of formality (e.g., formal, semi-formal, and informal or colloquial). For example only, the level of formality could be a value between one and zero, where a value of one indicates formal text and a value of zero indicates informal text. Such a value could be indicative of a degree of confidence that a set of words is formal versus informal. For example, of four manual annotations, three may have been formal and one may have been informal, and thus the score could be 0.75 (where 1.0 indicates formal), which corresponds to a ratio of 3:1 formal versus informal.

At 308, the server computing device 104 can determine whether a request to obtain a translated text has been received (e.g., from the client computing device 108). If true, the method 300 can proceed to 312. Otherwise, the method 300 can end or return to 308. The translated text can represent a translation of a text from the source language to the target language. The text could be obtained, for example, by physical user input (e.g., typed characters) and/or user voice or speech input. The text could also be selected from text that is currently displayed by the client computing device 108. For example, the client computing device 108 could be in the process of composing an electronic message (a text message, an email, etc.).

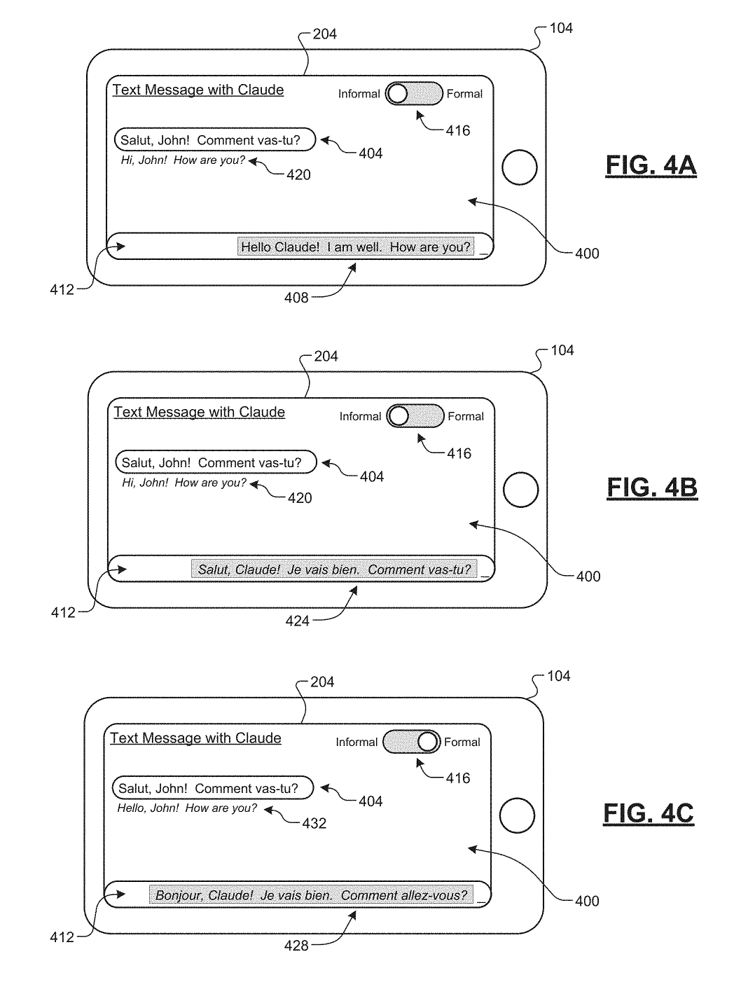

Referring now to FIG. 4A and with continued reference to FIG. 3A, an example user interface 400 displayed on a user interface 204 (e.g., a touch display) of the client computing device 108 is illustrated. As shown, the client computing device 108 is composing a text message, which is one of a plurality of types of electronic messages (email, real-time text chat, etc.). The text message is addressed to a French speaker (Claude) and is in response to a received message 404. The received message 404 reads “Salut, John! Comment vas-tu?” The first user 116 (John) is inputting a text 408 in a text entry area 412 of the user interface. The text 408 reads “Hello Claude! I am well. How are you?” As shown, an entire portion of the text 408 has been highlighted for translation from a source language (English) to a target language (French). The translation can be initiated, for example, either automatically upon selection or in response to selecting another command, such as from a menu that includes a “Translate” option or command.

The request can further specify a desired level of formality for the translated text. In some implementations, the desired level of formality is manually specified by the user 116. As shown, for example, a toggle button 416 is utilized by the first user 116 (John) to switch between “Formal” and “Informal” for the desired level of formality for translation. In FIGS. 4A-4B, the toggle button 416 is set to “Informal.” In other implementations, the desired level of formality is predetermined (e.g., a default of informal). In other implementations, the desired level of formality is automatically determined by the client computing device 108 and/or the server computing device 104 based on other criteria.

One example of such criteria is past user activity. For example, a history of past communications between the user 116 (John) and the recipient of the electronic message (Claude) can be analyzed to determine a level of formality previously used. As shown in FIG. 4A, Claude's message utilizes the terms “Salut” and “vas-tu.” The French word “salut” typically translates to “hi,” which is an informal version of the word “hello.” The pronoun “tu” and the verb “vas” also correspond the informal version of the word “you.” A previous translation 420 of received message 404 similarly reads “Hi, John!” These past communications may be stored and subsequently analyzed to determine a likely level of formality for communications between particular users. An actual or social network relationship could also be leveraged in determining the desired level of formality. This analysis can involve utilizing the machine translation model to label portions of past communications with level(s) of formality.

This determined likely level of formality can be utilized as the desired level or formality, or can be weighted and used as a factor in determining the desired level of formality. For example, when past communications between two users are analyzed and determined to be formal from both ends/users, the desired level of formality is very likely to be formal. On the other hand, for example, past communications between the two users could be analyzed and one user/end could be determined to be formal whereas the other user/end could be determined to be informal. While this could be indicative of the desired level of formality for the sending user, these past communications may not be particularly indicative of the desired level of formality for the conversation as a whole. Other factors could be weighted more heavily in determining the desired level of formality.

Different modes of communication can also have different desired levels of formality associated therewith. Email, for example, may be a more formal communication mode than text messaging. This could be determined, for example, based on past communications between the sender/recipient(s) and/or could be determined based on the desired level of formality for an average/aggregate user with respect to a particular communication mode. For example only, if Claude and John typically utilize formal text when emailing each other, but typically utilize informal text when text messaging, then the desired level of formality for email would more likely be formal whereas the desired level of formality for text messaging would more likely be informal. These determined or likely desired levels of formality can be stored, for example, in a user profile associated with the recipient and can be later retrieved during future communications.

At 312, the server computing device 104 can obtain the translated text by translating the text 408 using the machine translation model and the desired level of formality. It will be appreciated that some or all of the actual machine translation could also be performed by another server computing device or server computing system that utilizes the machine translation model. The translated text can comprise a first set of target words that is labeled with a level of formality that corresponds to the desired level of formality. This translation can involve calculation of probability scores indicative of a likelihood that the associated word(s) are an appropriate translation, which is discussed in greater detail below This correspondence between the labeled level of formality and the desired level of formality could be either an exact match (e.g., both labeled as formal) or satisfying some other criteria (e.g., a labeled formality value of 0.9 being within a threshold of 0.1 from the desired value of 1.0 that indicates formal text).

Other suitable scoring and criteria for identifying a particular set of target words that corresponds to the desired level of formality could also be utilized. In some implementations, the most appropriate or likely translation may not be selected because it does not correspond to the desired level of formality. For illustrative purposes, translating the text could comprise obtaining a probability score for the first set of target words and a second set of target words, where each probability score is indicative of a likelihood that its respective set of target words is an appropriate translation of a set of source words corresponding to the text. Even though the probability score for the second set of target words is greater than the probability score for the first set of target words, the first set of target words can be selected for the translated text because it is closer to the desired level of formality.

At 316, the server computing device 104 can output the translated text (e.g., to the client computing device 108 via the network 112). Receipt of the translated text can cause the client computing device 108 to display the translated text. For example, if the client computing device 108 was in the process of composing the electronic message, the translated text could be inserted into the electronic message in place of the text. As shown in FIG. 4B, a translated text 424 is displayed in place of the text 408. The translated text 424 reads “Salut, Claude! Je vais bien. Comment vas-tu?” It will be appreciated that, instead of automatically replacing the text 408, the translated text 424 could also be displayed proximate to the text, and the user 116 could be prompted to confirm that she/he wishes to replace the text with the translated text. The method 300 can then end or return to 308.

FIG. 4C further illustrates the changes to the user interface 400 and the translated text 424 when the toggle switch 416 is switched from “Informal” to “Formal” by the first user 116 (John). A modified translated text 428 is obtained by the server computing device 104 using the modified desired level of formality (Formal). The modified translated text 428 reads “Bonjour, Claude! Je vais bien. Comment allez-vous?” The French word “bonjour” typically translates to “hello,” which is a formal version of the word “hi.” The pronoun “vous” and the verb “allez” also correspond the formal version of the word “you.” In some implementations, the previous translation 420 of received message 404 is also modified in response to this change in the desired level of formality. As shown, the modified translation 432 now reads “Hello, John!” This is the formal version of “Hi, John!”

Referring now to FIG. 3B and with continued reference to FIGS. 4A-4C, a flow diagram of a second example method 350 for handling formality in translations of text is illustrated. At 354, the client computing device 108 can determine whether a text 408 in a source language (English) has been obtained (e.g., via a selection by the user 116). If true, the method 350 can proceed to 358. Otherwise, the method 300 can end or return to 354. At 358, the client computing device 108 can determine a desired level of formality for a translated text 424 or 428 representing a translation of the text 408 from the source language to a different target language. As previously discussed, this desired level of formality could be preset, manually-specified by the user 116 (e.g., via toggle button 416), or automatically determined (e.g., based on a history of past communication between users). As previously discussed, FIG. 4A illustrates the user selection of a portion of text 408 and the toggle button 416 that is initially switched to “Informal” (and in FIG. 4C, to “Formal”).

At 362, the client computing device 108 can transmit, to the server computing device 104, a request to translate the text 408 to the target language (French), the request further specifying the desired level of formality. As previously described, receipt of the request causes the server computing device 104 to: obtain the translated text by translating the text 408 from the source language to the target language using a machine translation model and the desired level of formality. At 366, the client computing device 108 can determine whether the translated text has been received. If true, the method 350 can proceed to 370. Otherwise, the method 350 can end (e.g., timeout) or return to 366. At 370, the client computing device can output the translated text. For example, the translated text could be output in place of or proximate to the text while composing an electronic message. FIG. 4B, for example, illustrates the informal translated text 424 having replaced the text 408, whereas FIG. 4C illustrates the formal translated text 428 replacing the text 408 (or the informal translated text 424). The method 350 can then end or return to 354.

Further to the descriptions above, a user may be provided with controls allowing the user to make an election as to both if and when systems, programs or features described herein may enable collection of user information (e.g., information about a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
obtaining, by a server computing device, a machine translation model relating sets of source words in a source language to sets of target words in a different target language, each of the sets of source words and target words being labeled with a level of formality with respect to its corresponding language;
receiving, by the server computing device, a request to obtain a translated text representing a translation of a text from the source language to the target language, the request further specifying a desired level of formality for the translated text;
in response to receiving the request, obtaining, by the server computing device, the translated text by translating the text using the machine translation model and the desired level of formality; and
outputting, by the server computing device, the translated text.

2. The computer-implemented method of claim 1, wherein the translated text comprises a first set of target words that is labeled with a level of formality that corresponds to the desired level of formality.

3. The computer-implemented method of claim 2, wherein translating the text comprises obtaining a probability score for the first set of target words and a second set of target words, each probability score being indicative of a likelihood that its respective set of target words is an appropriate translation of a set of source words corresponding to the text, and wherein the probability score for the second set of target words is greater than the probability score for the first set of target words.

4. The computer-implemented method of claim 1, wherein each of the labeled and desired levels of formality is either formal or informal.

5. The computer-implemented method of claim 1, wherein each of the labeled and desired levels of formality is one of three or more levels of formality ranging from informal to formal.

6. The computer-implemented method of claim 1, wherein the machine translation model is a phrase-based machine translation model that comprises a labeled phrase table comprising a plurality of pairs of parallel phrases, wherein each pair of parallel phrases comprises a source phrase in the source language and a target phrase in the target language, and wherein each source phrase and each target phrase is labeled with the level of formality.

7. The computer-implemented method of claim 1, wherein the machine translation model is a neural network-based machine translation model.

8. A server computing device, comprising:
a non-transitory computer-readable medium having a set of instructions stored thereon; and
one or more processors configured to execute the set of instructions, which causes the server computing device to perform operations comprising:
obtaining, by a server computing device, a machine translation model relating sets of source words in a source language to sets of target words in a different target language, each of the sets of source words and target words being labeled with a level of formality with respect to its corresponding language;
receiving, by the server computing device, a request to obtain a translated text representing a translation of a text from the source language to the target language, the request further specifying a desired level of formality for the translated text;
in response to receiving the request, obtaining, by the server computing device, the translated text by translating the text using the machine translation model and the desired level of formality; and
outputting, by the server computing device, the translated text.

9. The server computing device of claim 8, wherein the translated text comprises a first set of target words that is labeled with a level of formality that corresponds to the desired level of formality.

10. The server computing device of claim 9, wherein translating the text comprises obtaining a probability score for the first set of target words and a second set of target words, each probability score being indicative of a likelihood that its respective set of target words is an appropriate translation of a set of source words corresponding to the text, and wherein the probability score for the second set of target words is greater than the probability score for the first set of target words.

11. The server computing device of claim 8, wherein each of the labeled and desired levels of formality is either formal or informal.

12. The server computing device of claim 8, wherein each of the labeled and desired levels of formality is one of three or more levels of formality ranging from informal to formal.

13. The server computing device of claim 8, wherein the machine translation model is a phrase-based machine translation model that comprises a labeled phrase table comprising a plurality of pairs of parallel phrases, wherein each pair of parallel phrases comprises a source phrase in the source language and a target phrase in the target language, and wherein each source phrase and each target phrase is labeled with the level of formality.

14. The server computing device of claim 8, wherein the machine translation model is a neural network-based machine translation model.

15. A computer-implemented method, comprising:
obtaining, by a client computing device, a text in a source language;
determining, by the client computing device, a desired level of formality for a translated text representing a translation of the text from the source language to a different target language;
transmitting, by the client computing device and to a server computing device, a request to translate the text to the target language, the request further specifying the desired level of formality, wherein receipt of the request causes the server computing device to:
obtain the translated text by translating the text from the source language to the target language using a machine translation model and the desired level of formality, wherein the machine translation model relates sets of source words in the source language to sets of target words in the target language, each of the sets of source words and target words being labeled with a level of formality with respect to its corresponding language;
receiving, by the client computing device and from the server computing device, the translated text; and
outputting, by the client computing device, the translated text.

16. The computer-implemented method of claim 15, wherein each of the desired and labeled levels of formality is either formal or informal.

17. The computer-implemented method of claim 16, further comprising receiving, by the client computing device and from a user, an input specifying the desired level of formality as either formal or informal.

18. The computer-implemented method of claim 16, further comprising displaying, by the client computing device, a toggle button configured to switch between the desired level of formality being formal and informal, wherein the input received from the user is received with respect to the toggle button.

19. The computer-implemented method of claim 15, wherein determining the desired level of formality is performed by the client computing device without any specific input from the user.

20. The computer-implemented method of claim 19, further comprising initiating, by the client computing device, composition of an electronic message from the user to a recipient, wherein determining the desired level of formality is performed by the client computing device based on a history of communications between the user and the recipient.
